(19) United States
(12) Patent Application Publication
(10) Pub. No.: US 2014/0056584 A1
(43) Pub. Date: Feb. 27, 2014

(54) Reconfigurable Optical Add-Drop Multiplexer and Optical Network Element

(71) Applicants: Francesco Testa, Pomezia Roma (IT); Mauro Rudi Casanova, Carugate (MI) (IT); Antonio D' Errico, Calci (PI) (IT)

(72) Inventors: Francesco Testa, Pomezia Roma (IT); Mauro Rudi Casanova, Carugate (MI) (IT); Antonio D' Errico, Calci (PI) (IT)

(73) Assignee: Telefonaktiebolaget L M Ericsson (publ), Stockholm (SE)

(21) Appl. No.: 14/005,122

(22) PCT Filed: Mar. 15, 2011
(86) PCT No.: PCT/EP2011/053852

§ 371 Date: Sep. 23, 2013

(51) Int. Cl. H04J 14/02

(52) U.S. Cl. CPC H04J 14/0212
USPC 398/49; 398/50

(57) ABSTRACT

A reconfigurable optical add-drop multiplexer (10) comprising an input (20), an output (22), drop outputs (30), add inputs (22), a demultiplexer (18), a cross-connect element (12), a drop element (34) and an add element (26). The cross-connect element (12) comprises cross-connect outputs (36), a by-pass output (38), and optical switches (14) connected together as a first switch array. The drop element (34) comprises optical switches (14) connected together as a second switch array. The add element (26) comprises optical switches (14) connected together as a third switch array. Each optical switch (14) comprises a first input (13), a second input (15), a first output (17) and a second output (19). Each optical switch is arranged to deliver a first optical signal received at the first input to the first output. Each optical switch (14) is arranged to receive a respective control signal arranged to cause the optical switch to route a second optical signal received at its second input to a selected one of its first output and its second output.

### TECHNICAL FIELD

The invention relates to a reconfigurable optical add-drop multiplexer. The invention further relates to an optical network element.

### BACKGROUND

All-optical transport nodes currently deployed by network operators are based on multi-directional-switching ROADMs (Reconfigurable Add and Drop Multiplexers), to enable the transport nodes to be used in meshed network architectures. Currently available multi-directional-switching ROADMs are based on a 1×N WSS (wavelength selective switch) that is implemented in a mechanical package by using free space optics. Each channel is steered to a respective output port using a Liquid Crystal (LC) and MEMS devices. Bulk optics gratings are used to multiplex or demultiplex the optical signals.

The next generation of ROADMs will require an increasing level of flexibility to allow adding or dropping of any set of wavelengths from any link direction to any add/drop access port. A ROADM implementing flexible colourless/directionless/contentionless routing using free space 1×N WSS has been proposed which interconnects a number of WSS devices plus a number of add/drop optical switches, splitters and tunable filters (S. Gringeri et al, “Flexible Architectures for Optical Transport Nodes and Networks”, IEEE Communications, July 2010, pages 40-50). In a fully flexible ROADM the number of expensive devices increases, the number of optical amplifiers also increases due to the high loss for signal distribution and switching in the add/drop modules leading to an increase of ROADM cost, footprint and power consumption.

### SUMMARY

It is an object to provide an improved reconfigurable optical add-drop multiplexer. It is a further object to provide an improved optical network element. It is a further object to provide an improved method of controlling a reconfigurable optical add-drop multiplexer.

A first aspect of the invention provides a reconfigurable optical add-drop multiplexer comprising an optical signal input arranged to receive optical signals at a first plurality, K, of different wavelengths, an optical signal output, a second plurality, M, of optical drop outputs, a said second plurality of optical add inputs, a demultiplexer, a cross-connect element, a drop element and an add element. The optical signal output is arranged to output optical signals for transmission. Each optical drop output is arranged to output a said optical signal to be dropped. Each optical add input is arranged to receive an optical signal to be added. The demultiplexer is coupled to the optical signal input and comprises an output for each of said first plurality of different wavelengths. The cross-connect element comprises a said first plurality of cross-connect outputs, a by-pass output, and a third plurality of optical switches connected together as a first switch array. Each said optical switch is arranged to receive a respective first control signal arranged to cause the first switch array to connect a selected one of the demultiplexer outputs to a selected one of the cross-connect outputs and the by-pass output. The drop element comprises a fourth plurality of optical switches connected together as a second switch array. Each said optical switch is arranged to receive a respective second control signal arranged to cause the second switch array to connect a selected one of the cross-connect outputs to a selected one of the drop outputs. The add element comprises a fifth plurality of optical switches connected together as a third switch array. Each said optical switch is arranged to receive a respective third control signal arranged to cause the third switch array to connect a selected one of the by-pass output and the optical add inputs to the optical signal output. Each optical switch comprises a first input, a second input, a first output and a second output. Each optical switch is arranged to deliver a first optical signal received at the first input to the first output. Each control signal is arranged to cause the respective optical switch to route a second optical signal received at the second input to a selected one of the first output and the second output.

The reconfigurable optical add-drop multiplexer may enable each of any optical signals received at the optical signal input to be either optically switched to the optical signal output or to be optically switched to an optical drop output. The reconfigurable optical add-drop multiplexer may further enable any optical signal present at any optical add input to be optically switched to the optical signal output. In this way, the reconfigurable optical add-drop multiplexer may enable colourless and contentionless routing of optical signals. This colourless and contentionless routing may enable network operators to optimize the resources utilization, eliminate manual intervention, and support re-routing functions in case of faults in a cost effective way.

In an embodiment, the reconfigurable optical add-drop multiplexer comprises a sixth plurality, N, of optical signal inputs each arranged to receive optical signals at said first plurality of different wavelengths. The reconfigurable optical add-drop multiplexer further comprises a said sixth plurality of optical signal outputs each arranged to output optical signals for transmission at said first plurality of different wavelengths. The reconfigurable optical add-drop multiplexer further comprises a said sixth plurality of demultiplexers each coupled to a respective optical signal input and each comprising an output for each of said first plurality of different wavelengths. The cross-connect element comprises a seventh plurality, NK, of cross-connect outputs, and a said sixth plurality of by-pass outputs. The first switch array is arranged to connect a selected one of the demultiplexer outputs to a selected one of the cross-connect outputs and the by-pass outputs. The second switch array is arranged to connect a selected one of the cross-connect outputs to a selected one of the drop outputs. The third switch array is arranged to connect a selected one of the by-pass outputs and the optical add inputs to a selected one of the optical signal outputs.

This may enable directionless routing of optical signals, whereby each of any optical signals received at any optical signal input may be either optically switched to an optical signal output or may be optically switched to an optical drop output. This may enable any optical signal present at any optical add input to be optically switched to any optical signal output.

In an embodiment, the first switch array is coupled between the demultiplexer outputs and the cross-connect outputs and each by-pass output. The second switch array is coupled between the cross-connect outputs and the drop outputs. The third switch array is coupled between each by-pass output and the optical add inputs and each optical signal output. Each optical switch is connected to at least one adjacent said optical switch by the first input of a first said optical switch being connected to the first output of a first adjacent said optical switch, the second input of the first optical switch being connected to the second output of a second adjacent said optical switch, the first output of the first optical switch being connected to the first input of a third adjacent said optical switch and the second output of the first optical switch being connected to the second input of a fourth adjacent said optical switch.

Each switch array therefore comprises an array of interconnected optical switches, each able to change the routing of a second optical signal to either the first or second output. The first switch array may therefore be configured to selectively connect any demultiplexer output to a selected one of the cross-connect outputs and the or each by-pass output. The second switch array may therefore be configured to selectively connect any cross-connect output to a selected drop output. The third switch array may therefore be configured to selectively connect any by-pass output or optical add input to a selected optical signal output.

In an embodiment, the first switch array comprises an N×NK array of optical switches, the second switch array comprises an NK×M array of optical switches, and the third switch array comprises an N×M array of optical switches.

In an embodiment, each optical switch of at least one of the first switch array and the second switch array comprises a fixed wavelength optical switch arranged to route a said second optical signal having a pre-selected wavelength to a selected one of the first output and the second output and to route one or more said first optical signals having a different wavelength to said pre-selected wavelength to the first output. Each fixed wavelength optical switch may therefore multiplex a second optical signal with one or more first optical signals by routing all of the received optical signals to the first output. Using fixed wavelength optical switches may reduce the optical loss suffered by an optical signal as compared to the optical loss that would be suffered using broad bandwidth optical switches. The reconfigurable optical add-drop multiplexer may therefore drop or by-pass optical signals at any wavelength within the pre-selected wavelength range.

In an embodiment, each optical switch of the third switch array comprises a wavelength tunable optical switch arranged to route a said second optical signal having a selected wavelength of a pre-selected wavelength range to a selected one of the first output and the second output and to route one or more said first optical signals having a different wavelength of said pre-selected wavelength range to the first output. Each tunable wavelength optical switch may therefore multiplex a second optical signal at a wavelength within the pre-selected wavelength range with one or more first optical signals by routing all of the received optical signals to the first output. Using tunable wavelength optical switches may reduce the optical loss suffered by an optical signal as compared to the optical loss that would be suffered using broad bandwidth optical switches. Using tunable wavelength optical switches may also enable the reconfigurable optical add-drop multiplexer to receive optical signals to be added which are generated by tunable wavelength optical sources, since the operating wavelength of the optical switches may be tuned to match the wavelength of the originating optical source.

The reconfigurable optical add-drop multiplexer may therefore add or by-pass optical signals at any wavelength within the pre-selected wavelength range.

In an embodiment, each optical switch comprises a microring resonator based electro-optic switch.

In an embodiment, each optical switch of the second switch array comprises a broad bandwidth optical switch arranged to route a said second optical signal having a wavelength within a pre-selected wavelength range to a selected one of the first output and the second output and only to route one or more said first optical signals having a wavelength different to said selected wavelength to the first output when a said second optical signal is routed to the second output. Each optical switch may therefore route a first optical signal having any wavelength within the pre-selected wavelength range to the first output only when a second optical signal is not being routed to the first output. Each optical switch may route a second optical signal having any wavelength within the pre-selected wavelength range to the first output or the second output.

In an embodiment, each optical switch comprises a Mach-Zehnder interferometer based electro-optic switch.

In an embodiment, each demultiplexer comprises an arrayed waveguide grating.

In an embodiment the number of optical drop outputs and the number of optical add inputs, M, is less than NK. In an embodiment the number of optical drop outputs and the number of optical add inputs, M, is given by: M=(NK)/4.

In an embodiment, each optical switch is fabricated on a single integrated photonic structure. In an embodiment, the reconfigurable optical add-drop multiplexer is fabricated on a single integrated photonic structure.

A second aspect of the invention provides a method of controlling a reconfigurable optical add-drop multiplexer as described in any of the above paragraphs. The method comprises selecting a said demultiplexer output and one of said cross-connect outputs and the by-pass output to be connected. A first path across the first switch array between the selected demultiplexer output and the selected one of said cross-connect outputs and the by-pass output is then selected. The method further comprises selecting one of the cross-connect outputs and one of the drop outputs to be connected. A second path across the second switch array between the selected cross-connect output and the selected drop output is then selected. The method further comprises selecting one of the by-pass output and the optical add inputs to be connected to the optical signal output. A third path across the third switch array to connect the selected one of the by-pass output and the optical add inputs to the optical signal output is then selected. The method further comprises generating and transmitting a respective first control signal for each optical switch of the first path required to route a said second optical signal received at its second input to its first output. The method further comprises generating and transmitting a respective second control signal for each optical switch of the second path required to route a said second optical signal received at its second input to its first output. The method further comprises generating and transmitting a respective third control signal for each optical switch of the third path required to route a said second optical signal received at its second input to its first output.

In an embodiment the method comprises selecting an eighth plurality of said first paths across the first switch array to connect a selected said eighth plurality of the demultiplexer outputs to respective selected ones of the cross-connect outputs and the by-pass output. The method comprises selecting a ninth plurality of said second paths across the second switch array to connect a selected said ninth plurality of the cross-connect outputs to respective selected ones of the drop outputs. The method comprises selecting a tenth plurality of said third paths across the third switch array to connect a selected said ninth plurality of the by-pass output and the optical add inputs to the optical signal output. The method comprises generating and transmitting a respective first control signal for each optical switch of each said first path required to route a said second optical signal received at its second input to its first output. The method comprises generating and transmitting a respective second control signal for each optical switch of each said second path required to route a said second optical signal received at its second input to its first output. The method comprises generating and transmitting a respective third control signal for each optical switch of each said third path required to route a said second optical signal received at its second input to its first output.

A third aspect of the invention provides an optical network element comprising at least one input, at least one output, a reconfigurable optical add-drop multiplexer as described in any of the above paragraphs and a controller. Each input is arranged to receive optical signals at a first plurality, K, of different wavelengths. Each output is arranged to output optical signals for transmission. The controller is arranged to control a configuration of each switch array of the reconfigurable optical add-drop multiplexer. The controller is arranged to select a first path across the first switch array to connect a selected one of the demultiplexer outputs to a selected one of the cross-connect outputs and the by-pass output. The controller is further arranged to select a second path across the second switch array to connect a selected one of the cross-connect outputs to a selected one of the drop outputs. The controller is further arranged to select a third path across the third switch array to connect a selected one of the by-pass output and the optical add inputs to the optical signal output. The controller is further arranged to generate and transmit a respective first control signal for each optical switch of the first path required to route a said second optical signal received at its second input to its first output. The controller is further arranged to generate and transmit a respective second control signal for each optical switch of the second path required to route a said second optical signal received at its second input to its first output. The controller is further arranged to generate and transmit a respective third control signal for each optical switch of the third path required to route a said second optical signal received at its second input to its first output.

In an embodiment, the controller is arranged to select an eighth plurality of said first paths across the first switch array to connect a selected said eighth plurality of the demultiplexer outputs to respective selected ones of the cross-connect outputs and the by-pass output. The controller is further arranged to select a ninth plurality of said second paths across the second switch array to connect a selected said ninth plurality of the cross-connect outputs to respective selected ones of the drop outputs. The controller is further arranged to select a tenth plurality of said third paths across the third switch array to connect a selected said ninth plurality of the by-pass output and the optical add inputs to the optical signal output. The controller is further arranged to generate and transmit a respective first control signal for each optical switch of each said first path required to route a said second optical signal received at its second input to its first output. The controller is further arranged to generate and transmit a respective second control signal for each optical switch of each said second path required to route a said second optical signal received at its second input to its first output. The controller is further arranged to generate and transmit a respective third control signal for each optical switch of each said third path required to route a said second optical signal received at its second input to its first output.

In an embodiment, the optical network element further comprises a said second plurality, M, of optical transmitters, each arranged to generate and transmit an optical signal at a different one of said second plurality of wavelengths. In an embodiment, each optical transmitter comprises a wavelength tunable optical transmitter. In an embodiment, the controller is further arranged to generate a respective wavelength control signal arranged to cause each optical signal transmitter to generate and transmit an optical signal at a selected one of said second plurality of wavelengths.

In an embodiment, the optical network element comprises an optical network node. In an embodiment, each output is arranged to be coupled to an optical communications transmission line for onward transmission of each optical signal for transmission.

Embodiments of the invention will now be described, by way of example only, with reference to the accompanying drawings.

### BRIEF DESCRIPTION OF THE DRAWINGS

FIG. 1 is a schematic representation of a reconfigurable optical add-drop multiplexer according to a first embodiment of the invention;

FIG. 2 is a schematic representation of a reconfigurable optical add-drop multiplexer according to a second embodiment of the invention;

FIG. 3 is a diagrammatic representation of a fixed wavelength optical switch suitable for use in at least one of the first switch array and the second switch array of the reconfigurable optical add-drop multiplexer of FIG. 2;

FIG. 4 is a diagrammatic representation of a broad bandwidth wavelength selective optical switch suitable for use in the second switch array of the reconfigurable optical add-drop multiplexer of FIG. 2;

FIG. 5 is a diagrammatic representation of a tunable wavelength optical switch suitable for use in the third switch array of the reconfigurable optical add-drop multiplexer of FIG. 2;

FIG. 6 is a schematic representation of an optical network element according to a third embodiment of the invention;

FIG. 7 is a schematic representation of an optical network element according to a fourth embodiment of the invention; and

FIG. 8 shows the steps of a method of controlling a reconfigurable optical add-drop multiplexer according to a fifth embodiment of the invention.

### DETAILED DESCRIPTION

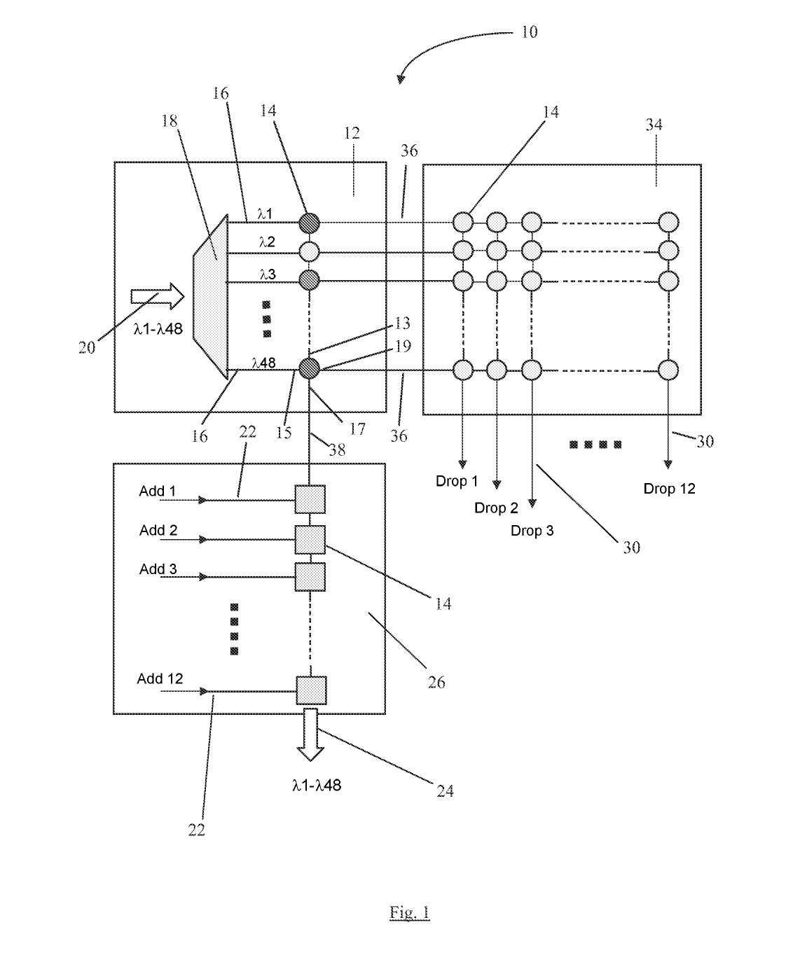

A first embodiment of the invention provides a reconfigurable optical add-drop multiplexer (ROADM) 10 as shown in FIG. 1. The ROADM 10 comprises an optical signal input 20 arranged to receive optical signals at a first plurality, K, of different wavelengths, an optical signal output 24, a second plurality, M, of optical drop outputs 30, a second plurality, M, of optical add inputs 22, a demultiplexer 18, a cross-connect element 12, a drop element 34 and an add element 26. In this example, the optical signal input 20 is arranged to receive 48 optical signals at each of 48 different wavelengths (X1 to X48). The optical signal output 24 is arranged to output optical signals for transmission at each of these 48 wavelengths. Each optical drop output 30 is arranged to output one of the received optical signals which is to be dropped at the ROADM 10. In this example, there are 12 drop outputs which may each output a drop signal at one of 12 of the 48 wavelengths at which optical signals may be received.

Each optical add input 22 is arranged to receive an optical signal to be added, in this example there are 12 optical add inputs 22, corresponding to the 12 drop outputs so that each optical signal that is dropped may be replaced by an optical signal to be added at the corresponding wavelength.

The demultiplexer 18 is coupled to the optical signal input 20 and comprises 48 outputs 16, that is one output 16 for each of the 48 different wavelengths.

The cross-connect element 12 comprises a first plurality, K, in this example 48, of cross-connect outputs 36 and a bypass output 38. Each cross-connect output 36 is arranged to deliver an optical signal to be dropped to the drop element 34 and the bypass output 38 is arranged to deliver each optical signal for onward transmission to the optical signal output 24, via the add element 26. The cross-connect element 12 further comprises a third plurality of optical switches 14, in this example there are 48 optical switches 14, one for each output from the demultiplexer 18. The optical switches 14 are connected together as a first switch array which is coupled between the demultiplexer outputs 16 and the cross-connect outputs 36 and the bypass output 38. Each optical switch 14 is arranged to receive a respective first control signal arranged to cause the first switch array to connect a selected demultiplexer output 16 to one of the cross-connect outputs 36 or the bypass output 38. The drop element 34 comprises a fourth plurality, KM, of optical switches 14. In this example 576 optical switches 14 are provided in the drop element 34. The optical switches 14 of the drop element 34 are connected together as a second switch array, which is coupled between the cross-connect outputs 36 and the drop outputs 30. Each optical switch 14 is arranged to receive a respective second control signal arranged to cause the second switch array to connect a selected cross-connect output 36 to a selected drop output 30.

The add element 26 comprises a second plurality, M, of optical switches 14 connected together as a third switch array, coupled between the bypass output 38, the add inputs 22 and the optical signal output 24. Each optical switch 14 of the add element 26 is arranged to receive a respective third control signal arranged to cause the third switch array to connect a selected one of the optical add inputs to the optical signal output. The third switch array is arranged always to connect the by-pass output 38 to the optical signal output 24.

Each optical switch 14 comprises a first input 13, a second input 15, a first output, 17, and a second output 19. Each optical switch 14 is arranged to deliver a first optical signal received at its first input 13 to its first output 17. Each optical switch 14 is arranged to selectively route a second optical signal received at its second input 15 to either its first output 17 or its second output 19. Each control signal is arranged to cause the respective optical switch 14 to route a received second optical signal to a selected one of its first output 17 or its second output 19. The path followed by an optical signal across a switch array may thereby be controlled by selecting which output an optical signal is routed to when received at the second input of each optical switch 14 that the optical signal encounters as it is transmitted across the switch array.

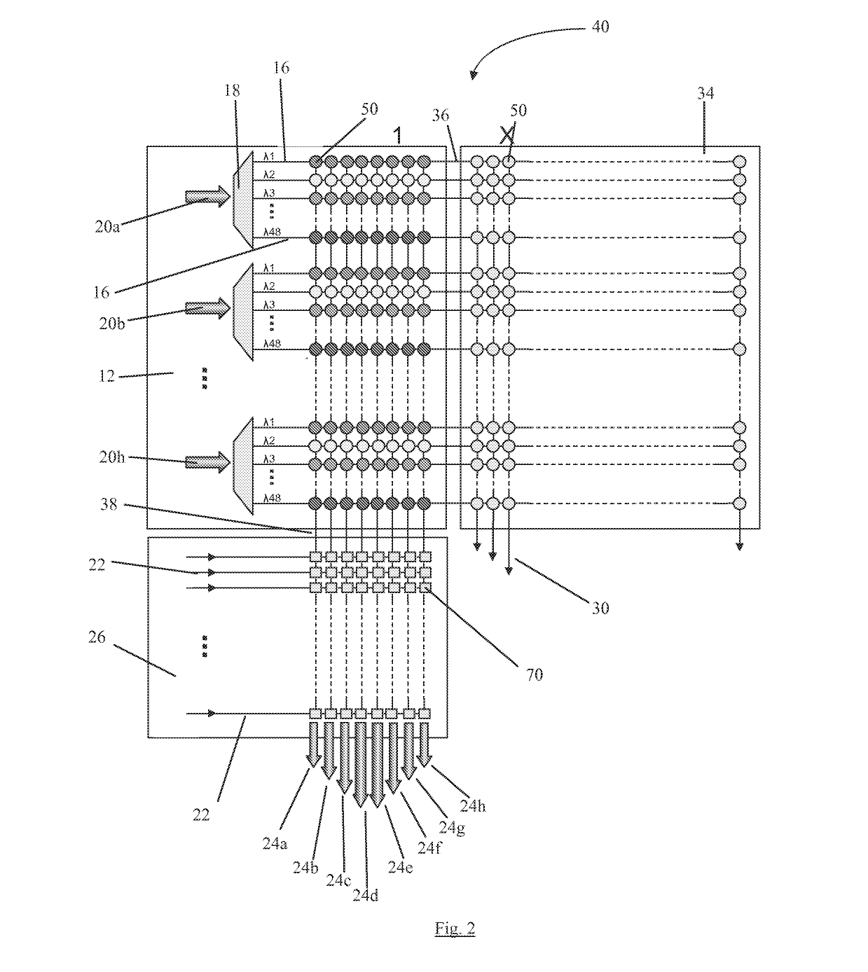

A second embodiment of the invention provides a ROADM 40 as shown in FIG. 2. The ROADM 40 of this embodiment is similar to the ROADM 10 of FIG. 1, with the following modifications. The same reference numbers are retained for corresponding features.

In this embodiment, the ROADM 40 comprises a sixth plurality, N, of optical signal inputs 20a, 20b-20h, each arranged to receive optical signals at the first plurality, K, of different wavelengths. In this example, the ROADM 40 comprises 8 optical signal inputs (only 3 are shown for clarity), and each optical signal input 20 is arranged to receive optical signals at each of the 48 different wavelengths. The ROADM 40 also comprises a corresponding plurality of optical signal outputs 24a to 24h, in this example 8 optical signal outputs are provided. Each optical signal output 24 is arranged to output optical signals for transmission at each of the 48 different wavelengths at which optical signals may be received.

The ROADM 40 of this embodiment comprises a corresponding sixth plurality, N, of demultiplexers 18 each coupled to a respective optical signal input 20.

The cross-connect element 12 of this example comprises a seventh plurality, NK, of cross-connect outputs 36, which in this example comprises 384 cross-connect outputs 36 and a said sixth plurality, N, in this example 8, of bypass outputs 38.

The cross-connect element 12 comprises a first switch array comprising N×NK optical switches 50, coupled between the demultiplexer outputs 16, the cross-connect outputs 36 and the bypass outputs 38. The first switch array is arranged to connect a selected demultiplexer output 16 to a selected one of the cross-connect outputs 36 and the bypass outputs 38.

In this example the drop element 34 comprises a second switch array comprising NK×(NK/4) optical switches 50 coupled between the cross-connect outputs 36 and the drop outputs 30. The drop element 34 of this embodiment comprises NK/4 drop outputs 30, that is to say in this example 96 drop outputs 30. It will be appreciated that the drop element 34 can have any number of drop outputs 30 up to NK. The second switch array is arranged to connect the selected cross-connect output 36 to a selected one of the drop outputs 30.

The add element 26 of this embodiment comprises a corresponding number of optical add inputs 24 to the number of drop outputs, that is to say the add element comprises NK/4 optical add inputs, which in this example comprises 96 optical add inputs 22. The add element 26 of this embodiment comprises a third switch array comprising N×(NK/4) optical switches 70 coupled between the bypass outputs 38, the optical add inputs 22 and the optical signal outputs 24a to 24h. The third switch array is arranged to connect a selected one of the bypass outputs 38 and the optical add inputs 22 to a selected optical signal output 24.

In operation, an input optical signal comprising a comb of up to 48 optical signals at different ones of the 48 wavelengths is received at each optical signal input 20 and is demultiplexed by the respective demultiplexer 18, and the resulting optical signals are output on a respective one of the demultiplexer outputs 16. Each optical signal proceeds horizontally (as orientated in FIG. 2) across the first switch array until it reaches the column of switches corresponding to the bypass output 38 of its destination optical signal output 24. The respective optical switch 50 receives a first control signal and is activated to cause the optical signal, which is received at its second input, to be routed to its first output, in the direction of the relevant bypass output 38. During transmission from the optical switch 50 towards the respective bypass output 38, optical signals at other wavelengths may also be switched into the same direction to form a comb of optical signals at different wavelengths to be output from the same optical signal output 24.

Any optical signal which is to be dropped at the ROADM 40 is transmitted across the first switch array and is output at the respective cross-connect output 36, where it is connected into the second switch array in the drop element 34. An optical signal to be dropped is transmitted horizontally across the drop element 34 until the column of switches 50 corresponding to its destination drop output 30 is reached. A second control signal is received by the respective optical switch 50, to cause the optical signal, received at the second input of the optical switch 50, to route the optical signal to be dropped to the first output of the optical switch 50, connected to the respective drop output 30.

Optical signals to be added are received at a respective optical add input 22 and are transmitted horizontally across the third switch array of the add element 26 until the optical switch 70 corresponding to the desired output direction 24 is reached. A third control signal is received by the respective optical switch 70 to cause the optical signal to be added to be routed to its second output 78, and then vertically towards the respective output 24.

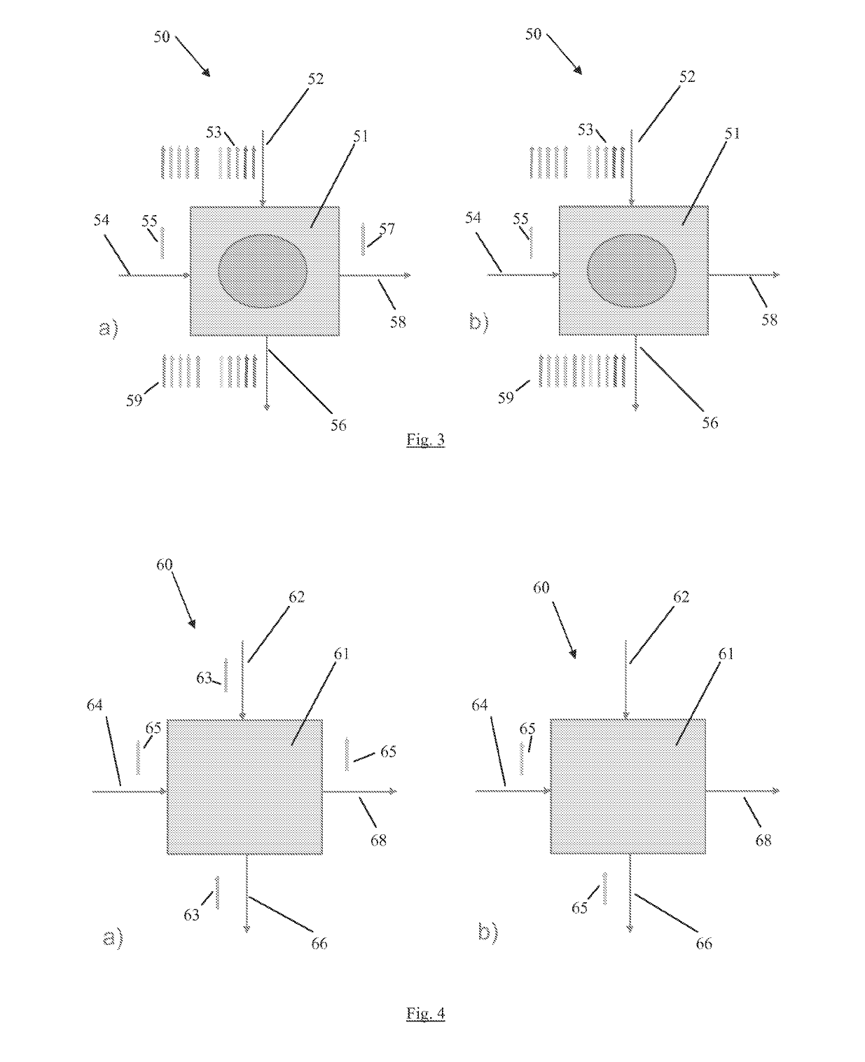

FIG. 3 shows a fixed wavelength optical switch suitable for use in either or both the first switch array of the cross-connect element 12 and the second switch array of the drop element 34 of the ROADM 40 of FIG. 2. The same reference numbers are retained for corresponding features.

The optical switch 50 of FIG. 3 is a wavelength selective 2×2 photonic switch (WSPS). The WSPS 50 of this embodiment comprises a microring resonator based electro-optic switch, such as that described in FIG. 3 of “Cascaded microring-based matrix switch for silicon on-chip optical interconnection”, Proceedings of the IEEE, volume 97, no 7, July 2009.

The WSPS 50 comprises a switch element and four uni-directional ports; a first input 52, a second input 54, a first output 56 and a second output 58. The WSPS 50 is arranged to route a first optical signal received at the first input 52 to the first output 56 and to route a second optical signal received at the second input 54 to the first output 56 or the second output 58. For example, a comb of optical signals 53, at a number of different wavelengths, received at the first input 52 will be routed to the first output 58. A second optical signal having a different wavelength, not present within the comb of wavelengths 53, received at the second input 54 will be routed to the second output 58, unless a first control signal is received and the switch element 51 is configured to route the second optical signal to the first output 56. The second optical signal 55 is thereby multiplexed with the comb of optical signals 53, to form a multiplexed optical signal 59.

The switch element 51 may be configured to route second optical signals having a wavelength within a pre-selected wavelength range, comprising the wavelength comb. That is to say the switch element 51 can be configured to switch optical signals received at the second input 54 at any one of the wavelengths of the comb of wavelengths 53 to the first output 56 or the second output 58.

In operation, if the second optical signal 55 is to be dropped to a drop output 30, the optical switch 50 will be configured to route the second optical signal 55 to the second output 58, for onwards transmission towards the respective cross-connect output 36, as shown in FIG. 3(a). Optical signals 53 received at the first input 52 that are to be routed to an optical signal output 24 are routed to the first output 56. If the second optical signal is to be routed to an optical signal output 24, the switch element 51 is configured by a first control signal to cause the second optical signal 55 to be routed to the first output 56, as shown in FIG. 3(b).

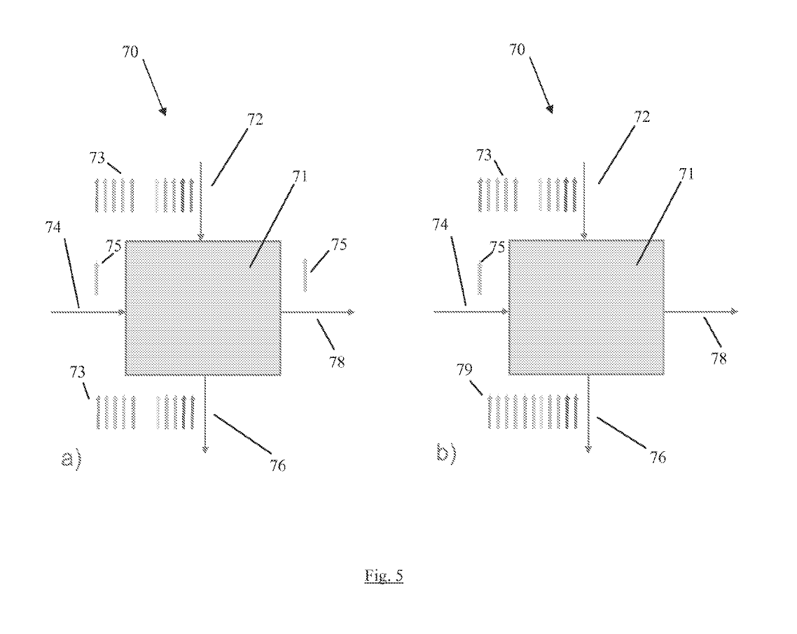

FIG. 4 shows a broad bandwidth optical switch 60, which in this example comprises a broadband photonic switch (BPS) 60 comprising a Mach-Zehnder interferometer. The BPS 60 may be used within the second switch fabric in the drop element 34.

The broadband photonic switch (BPS) 60 comprises a switch element 61, a first input 62, a second input, 64, a first output 66 and a second output 68. Each input 62, 64 and each output 66, 68 is unidirectional. As shown in FIG. 4(a), the BPS 60 is arranged to route a first optical signal 63 received at the first input 62 to the first output 66, if a second optical signal 65 received at the second input 64 is routed to the second output 68. A second optical signal 65, having a different wavelength, may therefore be simultaneously routed from the second input 64 to the second output 66. The BPS 60 is arranged to selectively route the second optical signal 65 to either the first output 66 or the second output 68, in response to receipt of a respective second or third control signal. If a control signal has been received the switch element 61 is configure to route a second optical signal 65 received at the second input 64 to the first output 66, as shown in FIG. 4(b). When the BPS 60 is in this configuration no first optical signal received at the first input 62 will be routed since only one wavelength is allowed to be dropped to each drop output 30. The BPS 60 therefore does not multiplex optical signals at its first output 66, the BPS 60 only routes one signal to an output 66, 68 at one time.

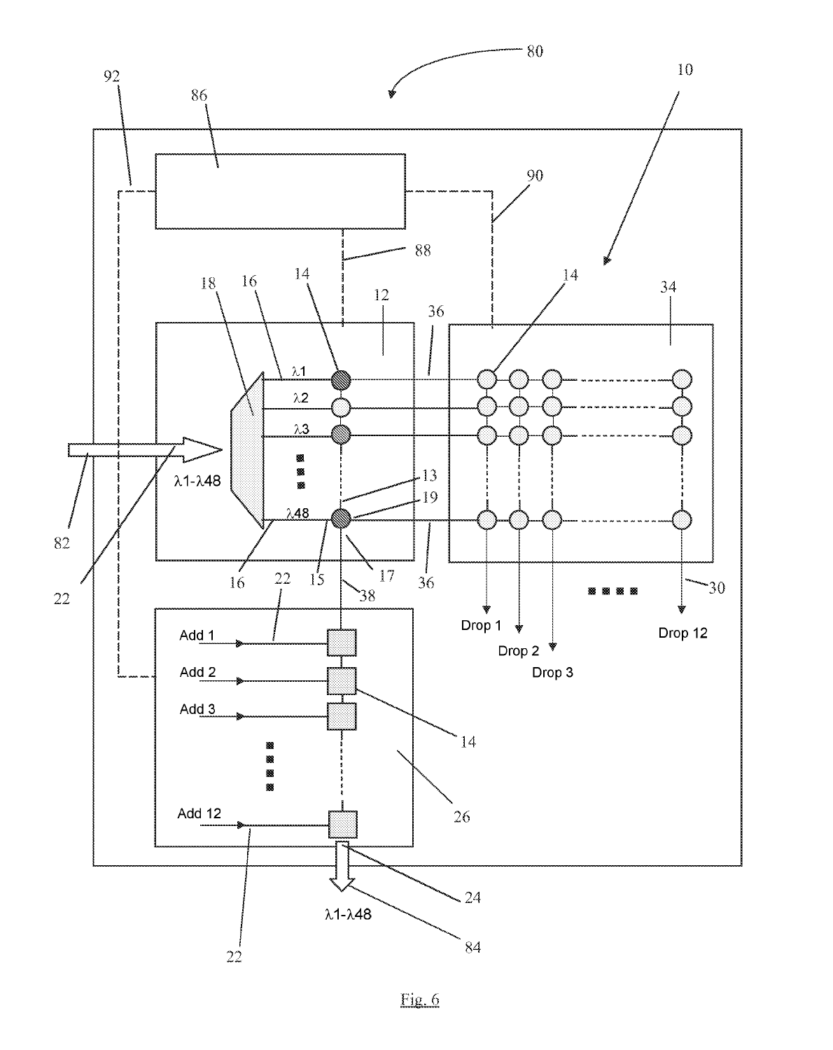

FIG. 5 shows a tunable wavelength optical switch (TPS) 70 for use in the third switch array of the add element 26 of the ROADM 40 shown in FIG. 2. The TPS 70 of this example comprises a tunable microring resonator, such as that described in “low power and compact reconfigurable multiplexing devices based on silicon microring resonators”, Optics Express, volume 18, no. 10.

The TPS 70 comprises a switch element 71, a first input 72, a second input 74, a first output 76 and a second output 78. As shown in FIG. 5(a), the TPS 70 is arranged to route a comb of first optical signals 73, each at different wavelengths, received at the first input 72 to the first output 76. The TPS 70 is also arranged to route a second optical signal 75, at a different wavelength to the wavelengths present within the comb of signals 73, received at the second input 74 to either the first output 76 or the second output 78. The second optical signal 75 may be selectively routed to the first output 78 following receipt of a third control signal. The second optical signal 75 may therefore be added to the comb of first optical signals 73 received at the first input 72 to form a multiplexed optical signal 79 delivered at the first output 78.

The wavelength of the second optical signal 75 may be tuned to be selected from any one of a pre-selected range of wavelengths, including all of the wavelengths within the comb of optical signals 73.

Each of the switch arrays of the cross-connect element 12, the drop element 34 and the add element 26 can be constructed by monolithic integration on a single Indium Phosphate or silicon semi-conductor material based die, each element then being interconnected to form the ROADM 40. Alternatively, all of the elements of the ROADM 40 may be formed as a single monolithic Indium Phosphate or silicon semi-conductor device. A colourless, directionless and contentionless ROADM may therefore be provided which offers low power consumption, low cost, a high degree of compactness and low interconnection complexity.

A third embodiment of the invention provides an optical network element 80, as shown in FIG. 6. The optical network element 80 comprises an input 82, and output 84, a ROADM 10 and a controller 86.

The input 82 is arranged to receive optical signals at a first plurality, K of different wavelengths. The input 82 is coupled to the input of the ROADM 10. The output 84 is arranged to output optical signals for transmission and is coupled to the output of the ROADM 10. The ROADM 10 is as shown in FIG. 1 and described above, and the same reference numbers are retained. It will be appreciated that the ROADM 40 of FIG. 2 may alternatively be used.

The controller 86 is arranged to control a configuration of each switch array of the ROADM 10. The controller 86 is arranged to select a first path across the first switch array of the cross-connect element 12 of the ROADM 10, to connect a selected demultiplexer output 16 to one of the cross-connect outputs 36 or the bypass output 38. The controller 86 is further arranged to select a second path across the second switch array of the drop element 34, to connect one of the cross-connect outputs 36 to one of the drop outputs 30. The controller 86 is further arranged to select a third path across the third switch array of the add element 26, to connect one of the optical add inputs 22 or the bypass output 38 to the optical signal output of the ROADM 10 for delivery to the output 84 of the optical network element 80.

The controller 86 is arranged to generate and transmit a first control signal 88 for each optical switch 14 of the first path which is required to route optical signals received at its second input 15 to its first output 17. The controller 86 is further arranged to generate and transmit a respective second control signal 90 for each optical switch 14 of the second path which is required to route a second optical signal received at its second input to its first output. And the controller 86 is further arranged to generate and transmit a respective third control signal 92 for each optical signal of the third path across the add element 26 which is required to route a second optical signal from its second input to its first output. The controlled may thereby configure the path to be followed by an optical signal across a switch array by selecting which output an optical signal is routed to when received at the second input of each optical switch 14 that the optical signal encounters as it is transmitted across the switch array.

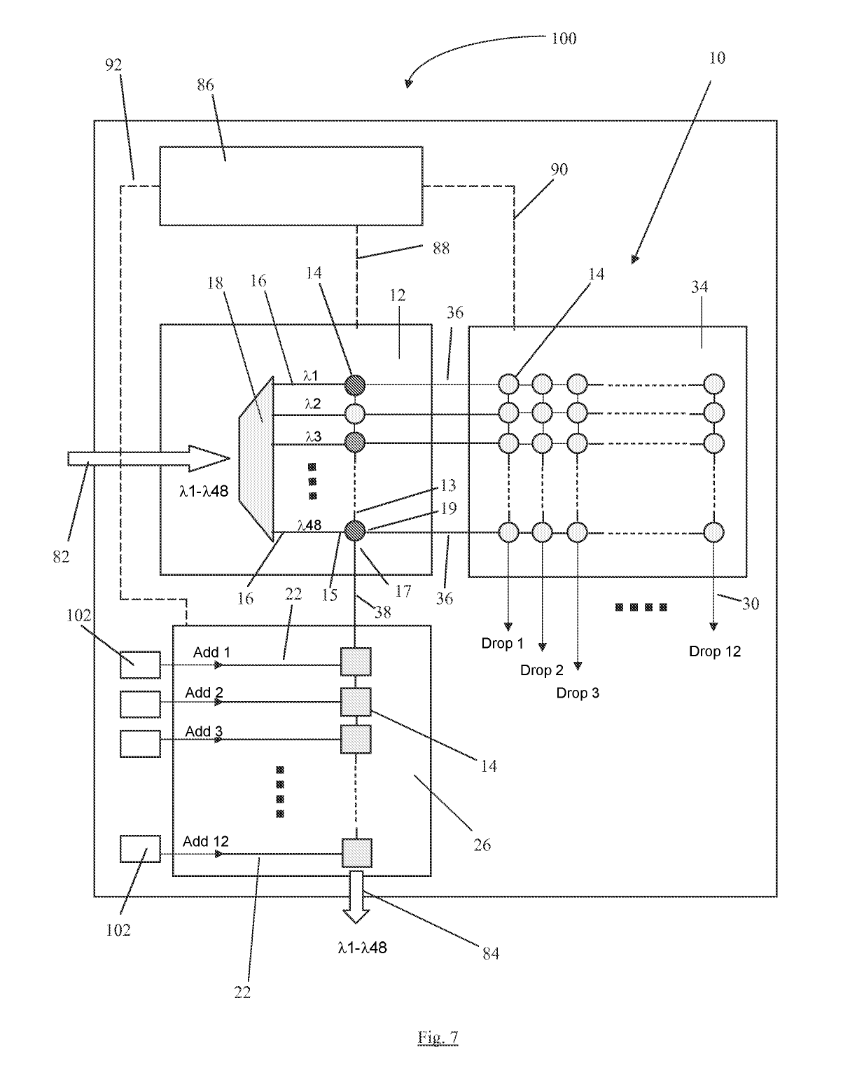

An optical network element according to a fourth embodiment of the invention is shown in FIG. 7. The optical network element 100 of this embodiment is similar to the optical network element 80 of FIG. 6, with the following modifications. The same reference numbers are retained for corresponding features.

In this embodiment the optical network element comprises an optical network node and further comprises 12 optical transmitters 102 each arranged to generate an optical signal to be added. Each optical transmitter 102 is coupled to a respective optical add input 22.

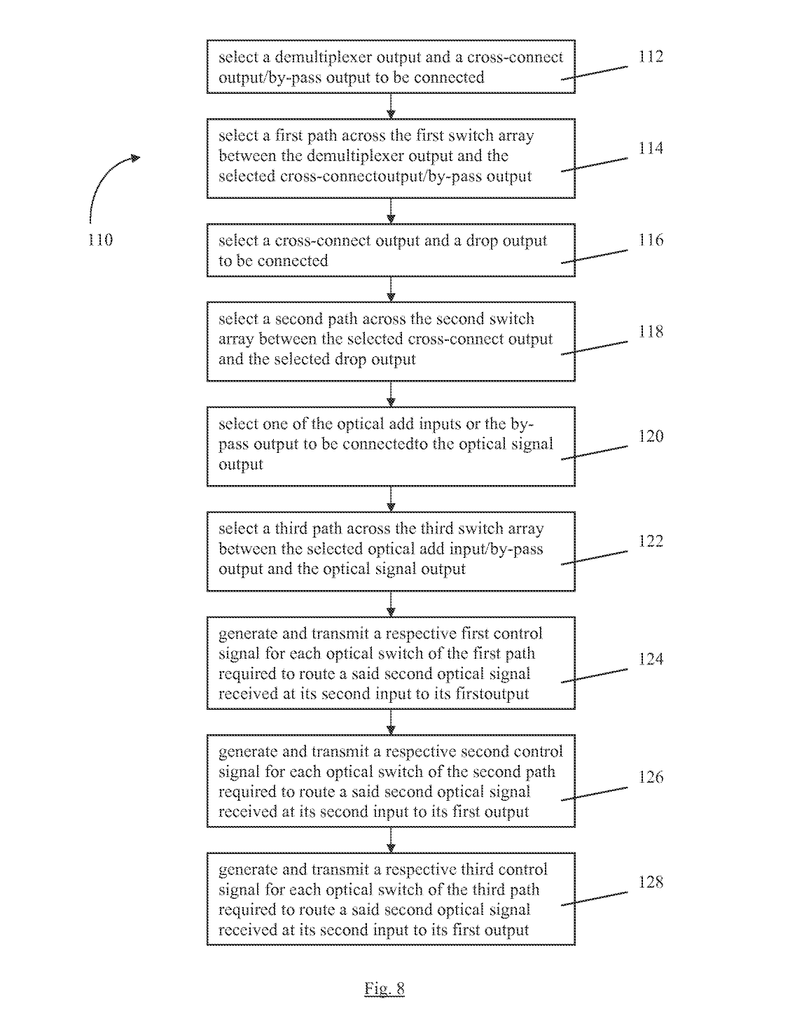

FIG. 8 shows the steps of a method 110 of controlling a ROADM 10, 40 as shown in FIG. 1 or FIG. 2, according to a fifth embodiment of the invention.

The method 110 comprises selecting 112 a demultiplexer output 16 and selecting a cross-connect output 36 or the by-pass output 38 to be connected to the selected demultiplexer output 16. A first path across the first switch array of the cross-connect element 12 is selected 114, between the selected demultiplexer output 16 and the selected cross-connect output 36 or by-pass output 38.

The method 110 further comprises selecting one of the cross-connect outputs 36 and one of the drop outputs 30 to be connected 116. A second path across the second switch array, of the drop element 34, is selected 118 between the selected cross-connect output and the selected drop output.

The method 110 further comprises selecting one of the optical add inputs or the by-pass output to be connected to the optical signal output 120. A third path across the third switch array, of the add element 22, is selected 122 to connect the selected optical add input or the by-pass output to the optical signal output.

A respective first control signal is generated and transmitted for each optical switch of the first path required to route a said second optical signal received at its second input to its first output 124. A respective second control signal is generated and transmitted for each optical switch of the second path required to route a said second optical signal received at its second input to its first output 126. A respective third control signal is generated and transmitted for each optical switch of the third path required to route a said second optical signal received at its second input to its first output 128.

1. A reconfigurable optical add-drop multiplexer comprising:
an optical signal input arranged to receive optical signals at a first plurality, K, of different wavelengths;
an optical signal output arranged to output optical signals for transmission;
a second plurality, M, of optical drop outputs each arranged to output a said optical signal to be dropped;
a said second plurality of optical add inputs each arranged to receive an optical signal to be added;
a demultiplexer coupled to the optical signal input and comprising an output for each of said first plurality of different wavelengths;
a cross-connect element comprising a said first plurality of cross-connect outputs, a by-pass output, and a third plurality of optical switches connected together as a first switch array, each said optical switch being arranged to receive a respective first control signal arranged to cause the first switch array to connect a selected one of the demultiplexer outputs to a selected one of the cross-connect outputs and the by-pass output;
a drop element comprising a fourth plurality of optical switches connected together as a second switch array, each said optical switch being arranged to receive a respective second control signal arranged to cause the second switch array to connect a selected one of the cross-connect outputs to a selected one of the drop outputs; and
an add element comprising a fifth plurality of optical switches connected together as a third switch array, each said optical switch being arranged to receive a respective third control signal arranged to cause the third switch array to connect a selected one of the by-pass output and the optical add inputs to the optical signal output,
wherein each optical switch comprises a first input, a second input, a first output and a second output and each optical switch is arranged to deliver a first optical signal received at the first input to the first output and each control signal is arranged to cause the respective optical switch to route a second optical signal received at the second input to a selected one of the first output and the second output.

2. The reconfigurable optical add-drop multiplexer as claimed in claim 1, wherein the reconfigurable optical add-drop multiplexer comprises:
a sixth plurality, N, of optical signal inputs each arranged to receive optical signals at said first plurality of different wavelengths;
a said sixth plurality of optical signal outputs each arranged to output optical signals for transmission at said first plurality of different wavelengths;
a said sixth plurality of demultiplexers each coupled to a respective optical signal input and each comprising an output for each of said first plurality of different wavelengths;
and wherein the cross-connect element comprises a seventh plurality, NK, of cross-connect outputs, and a said sixth plurality of by-pass outputs, and the first switch array is arranged to connect a selected one of the demultiplexer outputs to a selected one of the cross-connect outputs and the by-pass outputs;
the second switch array is arranged to connect a selected one of the cross-connect outputs to a selected one of the drop outputs; and
the third switch array is arranged to connect a selected one of the by-pass outputs and the optical add inputs to a selected one of the optical signal outputs.

3. The reconfigurable optical add-drop multiplexer as claimed in claim 1, wherein the first switch array is coupled between the demultiplexer outputs and the cross-connect outputs and each by-pass output, the second switch array is coupled between the cross-connect outputs and the drop outputs and the third switch array is coupled between each by-pass output and the optical add inputs and each optical signal output, and wherein each optical switch is connected to at least one adjacent said optical switch by the first input of a first said optical switch being connected to the first output of a first adjacent said optical switch, the second input of the first optical switch being connected to the second output of a second adjacent said optical switch, the first output of the first optical switch being connected to the first input of a third adjacent said optical switch and the second output of the first optical switch being connected to the second input of a fourth adjacent said optical switch.

4. The reconfigurable optical add-drop multiplexer as claimed in claim 2, wherein the first switch array comprises an N×NK array of optical switches, the second switch array comprises an NK×M array of optical switches, and the third switch array comprises an N×M array of optical switches.

5. the reconfigurable optical add-drop multiplexer as claimed in claim 1, wherein each optical switch of each of at least one of the first switch array and the second switch array comprises a fixed wavelength optical switch arranged to route a said second optical signal having a pre-selected wavelength to a selected one of the first output and the second output and to route one or more said first optical signals having a different wavelength to said pre-selected wavelength to the first output.

6. The reconfigurable optical add-drop multiplexer as claimed in claim 1, wherein each optical switch of the third switch array comprises a wavelength tunable optical switch arranged to route a said second optical signal having a selected wavelength of a pre-selected wavelength range to a selected one of the first output and the second output and to route one or more said first optical signals having a different wavelength of said pre-selected wavelength range to the first output.

7. The reconfigurable optical add-drop multiplexer as claimed in claim 5, wherein each optical switch comprises a microring resonator based electro-optic switch.

8. The reconfigurable optical add-drop multiplexer as claimed claim 1, wherein each optical switch of the second switch array comprises a broad bandwidth optical switch arranged to route a said second optical signal having a wavelength within a pre-selected wavelength range to a selected one of the first output and the second output and only to route one or more said first optical signals having a wavelength different to said selected wavelength to the first output when a said second optical signal is routed to the second output.

9. A method of controlling a reconfigurable optical add-drop multiplexer as claimed in claim 1, the method comprising:
selecting a said demultiplexer output and one of said cross-connect outputs and the by-pass output to be connected and selecting a first path across the first switch array between the selected demultiplexer output and the selected one of said cross-connect outputs and the by-pass output;
selecting one of the cross-connect outputs and one of the drop outputs to be connected and selecting a second path across the second switch array between the selected cross-connect output and the selected drop output;
selecting one of the by-pass output and the optical add inputs to be connected to the optical signal output and selecting a third path across the third switch array to connect the selected one of the by-pass output and the optical add inputs to the optical signal output;
generating and transmitting a respective first control signal for each optical switch of the first path required to route a said second optical signal received at its second input to its first output;
generating and transmitting a respective second control signal for each optical switch of the second path required to route a said second optical signal received at its second input to its first output; and
generating and transmitting a respective third control signal for each optical switch of the third path required to route a said second optical signal received at its second input to its first output.

10. The method as claimed in claim 9, wherein the method comprises:
selecting an eighth plurality of said first paths across the first switch array to connect a selected said eighth plurality of the demultiplexer outputs to respective selected ones of the cross-connect outputs and the by-pass output;
selecting a ninth plurality of said second paths across the second switch array to connect a selected said ninth plurality of the cross-connect outputs to respective selected ones of the drop outputs;
selecting a tenth plurality of said third paths across the third switch array to connect a selected said ninth plurality of the by-pass output and the optical add inputs to the optical signal output;
generating and transmitting a respective first control signal for each optical switch of each said first path required to route a said second optical signal received at its second input to its first output;
generating and transmitting a respective second control signal for each optical switch of each said second path required to route a said second optical signal received at its second input to its first output; and
generating and transmitting a respective third control signal for each optical switch of each said third path required to route a said second optical signal received at its second input to its first output.

11. An optical network element comprising:
an input arranged to receive optical signals at a first plurality, K, of different wavelengths;
an output arranged to output optical signals for transmission;
a reconfigurable optical add-drop multiplexer; and
a controller arranged control a configuration of each switch array of the reconfigurable optical add-drop multiplexer, the controller being arranged to:
select a first path across the first switch array to connect a selected one of the demultiplexer outputs to a selected one of the cross-connect outputs and the by-pass output;
select a second path across the second switch array to connect a selected one of the cross-connect outputs to a selected one of the drop outputs;
select a third path across the third switch array to connect a selected one of the by-pass output and the optical add inputs to the optical signal output;
generate and transmit a respective first control signal for each optical switch of the first path required to route a said second optical signal received at its second input to its first output;
generate and transmit a respective second control signal for each optical switch of the second path required to route a said second optical signal received at its second input to its first output; and
generate and transmit a respective third control signal for each optical switch of the third path required to route a said second optical signal received at its second input to its first output.

12. The optical network element as claimed in claim 11, wherein the controller is arranged to:
select an eighth plurality of said first paths across the first switch array to connect a selected said eighth plurality of the demultiplexer outputs to respective selected ones of the cross-connect outputs and the by-pass output;
select a ninth plurality of said second paths across the second switch array to connect a selected said ninth plurality of the cross-connect outputs to respective selected ones of the drop outputs;
select a tenth plurality of said third paths across the third switch array to connect a selected said ninth plurality of the by-pass output and the optical add inputs to the optical signal output;
generate and transmit a respective first control signal for each optical switch of each said first path required to route a said second optical signal received at its second input to its first output;
generate and transmit a respective second control signal for each optical switch of each said second path required to route a said second optical signal received at its second input to its first output; and
generate and transmit a respective third control signal for each optical switch of each said third path required to route a said second optical signal received at its second input to its first output.
